(19) United States
(12) Patent Application Publication
(10) Pub. No.: US 2004/0059862 A1
(43) Pub. Date: Mar. 25, 2004

(54) Method and apparatus for providing redundant bus control

(75) Inventor: Johni Chan, Rancho Santa Fe, CA (US)

Correspondence Address: FITCH EVEN TABIN AND FLANNERY, 120 SOUTH LA SALLE STREET, SUITE 1600, CHICAGO, IL, 60603-3406, US

(73) Assignee: I-Bus Corporation, San Diego, CA (US)

(21) Appl. No.: 10/065,185

(22) Filed: Sep. 24, 2002

(51) Int. Cl. G06F 13/36; G06F 13/00

(52) U.S. Cl. 710/316

(57) ABSTRACT

The present invention provides an apparatus, network and method for providing network communication. The network includes a first main bus; a first processor; a first hybrid switching module (HSM) coupled with the first processor wherein the first processor accesses the first main bus through the first HSM; the first HSM includes a first HSM redundant bus controller (RBC); a second processor coupled with the first main bus; and a second RBC coupled with the first HSM RBC, wherein the second RBC controls access to the first main bus when the first HSM RBC is inactive such that the second processor accesses the first main bus.

### BACKGROUND OF INVENTION

1. Field of the Invention

The present invention relates generally to input/output (I/O) data communication architecture, and more specifically to redundant bus control for I/O data communication architecture.

2. Discussion of the Related Art

During the past decade, the personal computer industry has literally exploded into the culture and business of many industrialized nations. Personal computers, while first designed for applications of limited scope involving individuals sitting at terminals, producing work products such as documents, databases, and spread sheets, have matured into highly sophisticated and complicated tools. What was once a business machine reserved for home and office applications, has now found numerous deployments in complicated industrial control systems, communications, data gathering, and other industrial and scientific venues. As the power of personal computers has increased by orders of magnitude every year since the introduction of the personal computer, personal computers have been found performing tasks once reserved to mini-computers, mainframes and even supercomputers.

In many of these applications, PC hardware and industry-standard software performs mission critical tasks involving significant stakes and low tolerance for failure. In these environments, even a single short-lived failure of a PC component can represent a significant financial event for its owner.

Standard off-the-shelf computers and operating systems are used in critical applications that require much higher levels of reliability than provided by most personal computers. They are used for communications applications, such as controlling a company's voice mail or e-mail systems. They may be used to control critical machines, such as check sorting, or mail sorting for the U.S. Postal Service. They are used for complicated industrial control, automaton, data gathering and other industrial and scientific applications. Computer failures in these applications can result in significant loss of revenue or loss of critical information. For this reason, companies seek to purchase computer equipment, specifically looking for features that increase reliability, such as better cooling, redundant, hot-swapable power supplies or redundant disk arrays. These features have provided relief for some failures, but these systems are still vulnerable to failures of the system or single board computer (SBC) within the personal computer system itself. If the processor, memory or support circuitry on a single board computer fails, or software fails, the single board computer can be caused to hang up or behave in such a way that the entire computer system fails. Some industry standards heretofore dictated that the solution to this problem is to maintain two completely separate personal computer systems, including redundant single board computers and interface cards. In many cases, these interface cards are very expensive, perhaps as much as ten times the cost of the single board computer.

As a result, various mechanisms for creating redundancy within and between computers have been attempted in an effort to provide backup hardware that can take over in the event of a failure.

In a typical computer system a common-bus architecture connects all components, which may include one or several central processing units (CPUs), random access memory (RAM), read-only memory (ROM), input/output (I/O) devices, disk drive controllers, direct memory access controllers (DMAC), secondary bus controllers such as a small computer systems interface (SCSI) or bus bridges to other buses such as a peripheral component interconnect (PCI), compact PCI, or an industry standard architecture (ISA) bus. Those components may all be disposed on a single plug-in board, or they may be implemented on a plug-in board as well as a motherboard. In the later case, the plug-in board(s) and the motherboard communicate via a bus. In some cases, data is shared by multiple CPUs using multiple port memories or data must be accessed by various components, one component at a time, or transferred from one component to another on a common bus.

The present invention advantageously addresses the above and other needs.

### SUMMARY OF INVENTION

The present invention advantageously addresses the needs above as well as other needs by providing an apparatus and method for controlling network data traffic. In one embodiment, the invention can be characterized as a network, comprising: a first processor including a first processor data channel; a first hybrid switching module (HSM) including a first HSM processor data channel coupled with the first processor data channel, a first HSM first bridge, a first HSM redundant bus controller (RBC) coupled with the first HSM first bridge, wherein the first HSM RBC includes a first HSM peer RBC channel, and the first HSM first bridge includes a first main bus channel; a first main bus coupled with the first HSM first bridge first main bus channel, such that the first HSM first bridge bridges communication between the first processor and the first main bus when authorized by the first HSM RBC; a second RBC having a second RBC peer RBC channel coupled with the first HSM RBC peer RBC channel; and a second processor including a second processor data channel coupled with the first main bus such that data is communicated between the second processor and the first main bus when the first HSM RBC is in standby.

In one embodiment, the invention provides a system, comprising: a first main bus; a first processor; a first hybrid switching module (HSM) coupled with the first processor wherein the first processor accesses the first main bus through the first HSM; the first HSM includes a first HSM redundant bus controller (RBC); a second processor coupled with the first main bus; and a second RBC coupled with the first HSM RBC, wherein the second RBC controls access to the first main bus when the first HSM RBC is inactive such that the second processor accesses the first main bus.

In one embodiment, the invention provides an apparatus for providing information flow over a data bus, comprising: a redundant bus controller (RBC); a first bridge having a first main bus channel, wherein the first bridge couples with the RBC; and a switch selectively coupled with the first bridge, wherein the first bridge bridges data between the first main bus channel and the switch when directed by the RCB.

The present invention provides for an apparatus for controlling access to a bus, comprising: a peer coupling to communicate state information; a control and status register; and a sequencer to transition the state of the apparatus. The apparatus can additionally include a register interface coupled with an arbiter.

A better understanding of the features and advantages of the present invention will be obtained by reference to the following detailed description of the invention and accompanying drawings that set forth an illustrative embodiment in which the principles of the invention are utilized.

### BRIEF DESCRIPTION OF DRAWINGS

The above and other aspects, features and advantages of the present invention will be more apparent from the following more particular description thereof, presented in conjunction with the following drawings wherein:

FIG. 1 depicts a simplified block diagram of a computer network according to one embodiment of the present invention;

FIG. 2 depicts a simplified block diagram of a network according to one embodiment of the present invention;

FIG. 3 illustrates is a simplified block diagram of a hybrid switching module (HSM);

FIG. 4 depicts a simplified block diagram of a computer network according to one embodiment of the present invention;

FIG. 5 depicts a state diagram of the operation of a redundant bus controller (RBC);

FIG. 6 depicts a simplified block diagram of an HSM that allows coupling, cooperation and control over a plurality of buses within a network;

FIG. 7 depicts a simplified block diagram of a computer network according to one embodiment of the present invention;

FIG. 8 depicts a simplified block diagram of a computer network 410 according to one embodiment of the present invention;

FIG. 9 depicts a simplified block diagram of an RBC 500 and some examples of the functional blocks that can be included within the RBC;

FIG. 10 depicts a simplified block diagram of two RBCs in an active/standby configuration and their relation to other components in a system in accordance with one embodiment of the present invention; and

FIG. 11 depicts a flow diagram showing a process for transitioning control over a bus from one host to another host.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

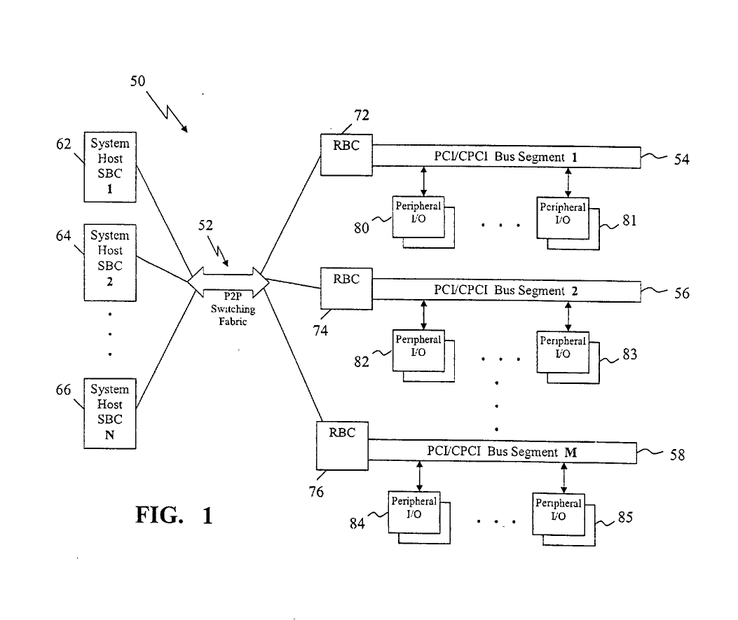

FIG. 1 depicts a simplified block diagram of a network 50 according to one embodiment of the present invention. The hardware infrastructure 52, established through a switching fabric (described fully below), interconnects multiple bus segments 54, 56, 58 (e.g., PCI, CPCI, H.110 and other buses) with multiple controller hosts 62, 64, 66. The hosts can be implemented through substantially any processor, microprocessor, central processing unit (CPU), system board computer or other controller. The bus ownership and/or control among the hosts is configured so that one host is assigned to be the system host on a bus segment at a given time. Substantially any host 62, 64, 66 can access substantially any bus 54, 56, 58 through redundant bus controllers (RBC) 72, 74, 76. An alternate host(s) is assigned as the backup host for the active system host. When a system controller host fails or is intentionally swapped out of control, the initial host is released of control and the designated alternate controller host takes over through the RBC as the host controller of the failing bus segment to perform bus I/O device enumeration for the peripheral I/O devices 80-85 of the bus. Depending on if the host switchover is cooperative or forced, the I/O devices might have to be reset upon restart of the drivers on the alternate host node.

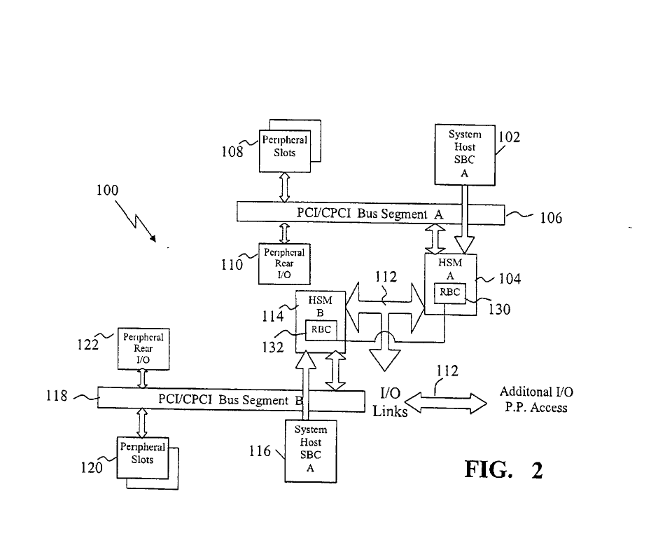

RBCs are installed on each bus segment in an active-standby configuration to allow multiple hosts to access a single bus. The swapping out of a system host (e.g., first host 62) controlling a bus (e.g., the first bus 54) causes a dynamic switchover through the RBC 74 of host functions to the designated alternate host node (e.g., third host 66). A new host (e.g., second host 64) is then designated as an alternate host node for the new active host node (e.g., third host 66) on the bus segment 54. The present invention provides for N hosts 62, 64, 66 to couple through the switching fabric 52 with M buses 54, 56 and 58. At least one RBC 72, 74, 76 is associated with each bus allowing a plurality of the hosts to access and control any one of the buses. The present invention provides for dynamic reconfiguration of one or more buses and device ownership among a plurality of servers. With the inclusion of RBCs 72, 74, 76 on each bus segment 54, 76, 58, respectively, the architecture supports a high availability system with no single point of failure. FIG. 2 depicts a simplified block diagram of a computer network 100 according to one embodiment of the present invention. The network includes a first host, processor, microprocessor, central processor unit (CPU), system or single board computer (SBC) 102 or other processor or controller coupled through a first hybrid switching module (HSM) 104 to a first data channel or bus, such as a first PCI or CPCI backplane bus 106. Coupled to the PCI or CPCI backplane bus 106 are a first plurality of PCI or CPCI peripheral slots 108, into which PCI or CPCI peripheral cards (not shown) can be inserted, and first user CPCI rear input/output devices 110. The first HSM 104 additionally couples with an I/O link 112. Through the I/O link 112 the first HSM 104 couples to a second HSM 114. The second HSM is connected to a second SBC 116, and also to a second channel or bus, such as a second PCI or CPCI backplane bus 118. Coupled to the second PCI or CPCI backplane bus 118 is a second plurality of PCI or CPCI peripheral slots 120, into which PCI peripheral cards (not shown) can be inserted, and second user CPCI rear input/output devices 122.

The first HSM 104 provides coupling of a flow of data between the first SBC 102 and the first PCI or CPCI 106. Similarly, the second HSM 114 provides coupling of a flow of data between the second SBC 116 and the second PCI or CPCI 118. In one embodiment, the first SBC 102 and the second SBC 116 establish control over their respective PCI or CPCI backplane buses 106, 118 through redundant bus controllers (RBC) 130, 132.

Further, through the I/O link 112, the first SBC 102 and the second SBC 116 can be coupled through the HSMs 104, 114 to substantially any other PCI bus within the computer network 100. For example, in the embodiment depicted in FIG. 2, the first SBC 102 (and similarly, the second SBC 116) can couple with both the first and second PCI or CPCI backplane buses in the computer network 100 through the HSMs 104, 114.

The RBCs 130, 132 further allow one of the SBCs of the network 100 to host and control the bus(es) (e.g., PCI or CPCI buses). In one embodiment, the RBC allows access to and control over the bus through know bus control techniques. The RBCs 130, 132, are further configured to allow alternate SBCs within the network 100 to gain access to the bus that the RBC is associated with and thus allow alternate SBCs to access the peripheral devices on that bus in the event of a failure and/or interrupt of the active host SBC associated with that bus. For example, if the first SBC 102 is the active controlling host of the first bus 106 through the HSM 104 and the first SBC 102 experiences an interrupt (whether a scheduled interrupt or an unscheduled interrupt), the second SBC 116 can gain access to and control over the bus 106 and the first peripheral devices 108, 110 through the second HSM 114 and the first HSM 104. The first RBC 130 allows the second SBC 116 to become the active host of the first bus 106 without the second SBC interacting with or go through the first SBC 102. Similarly, the first SBC 102 can access the second peripheral devices 120, 122 over the second bus 118 through the second HSM 114 and RBC 132 when the second SBC experiences a failure and/or interrupt.

The HSMs are conduits for the SBCs to access I/O devices on a bus segment through a switching fabric established, at least in part, through the I/O links 112. The RBCs 132, 132 of the HSMs avoids a single point of failure on the bus segments 106, 118. The HSMs 104, 114 are capable of providing the system clocks, performing other necessary system slot functions, such as bus arbitration, and other similar functions.

As is known in the art, PCI and/or CPCI bus architecture limits the control of the bus to a single component. RBCs are configured to dynamically reconfigure one or more of the buses and device ownership between the two SBCs.

In one embodiment, the RBCs 130, 132 are incorporated within the HSMs 104, 114, respectively. However, the RBCs can be independent components or part of other components of the network 100 (e.g., the RBCs can be part of the SBC). The RBCs allow for more than one component to access the PCI or CPCI bus and the peripheral devices thereon. When an SBC goes down, the RBC is notified and/or detects the SBC interrupt or failure. The RBC or other network component notifies an alternate SBC and/or broadcasts an alert or alarm across part or the entire network 100 of the failure. A secondary SBC assumes responsibility for the peripheral devices and the RBC allows the secondary SBC access to the bus. In one embodiment, the RBC is additionally configured to release and SBC″s control over the bus allowing a second SBC associated with the bus to take over control as described fully below.

The interrupts of an SBC can be scheduled or unscheduled providing a host switch over that is cooperative or forced, respectively. Unscheduled interrupts can occur when there is a failure, power outage or other fault with an SBC where the SBC can no longer access and/or control the bus. Alternatively, the SBCs can be scheduled to be interrupted or to halt operation allowing other SBCs to access peripherals without having to go through other SBCs. For example, the first SBC 176 can be interrupted to allow the second SBC 178 (or another SBC) to access peripheral devices without going through the first SBC.

In a cooperative host switchover, applications on the active host are stopped gracefully and hardware is put in a known good state, before the standby host takes over the domain and applications are restarted on the new active host. Alternatively, a forceful switchover is initiated when the active host does not cooperate. In one embodiment, the standby host forces the active host off the bus segment and takes over control of the bus. In a forceful switchover, the hardware may be left in an unknown or erroneous state. In some instances, the new active host may need to reset the bus to restore hardware to a known good state.

Because each of the SBCs 102, 116 is able to connect to each of the PCI peripheral slots 108, 120 and each of the user PCI input/output devices 110, 122, a tremendous amount of functionality is available to the user of the computer system 100. For example, in an eight-way multi-computing configuration, eight-way point-to-point connectivity and redundancy is enabled by the present embodiment. The same connectivity can be applied directly as I/O chassis connectivity as the industry migrates into point-to-point architecture.

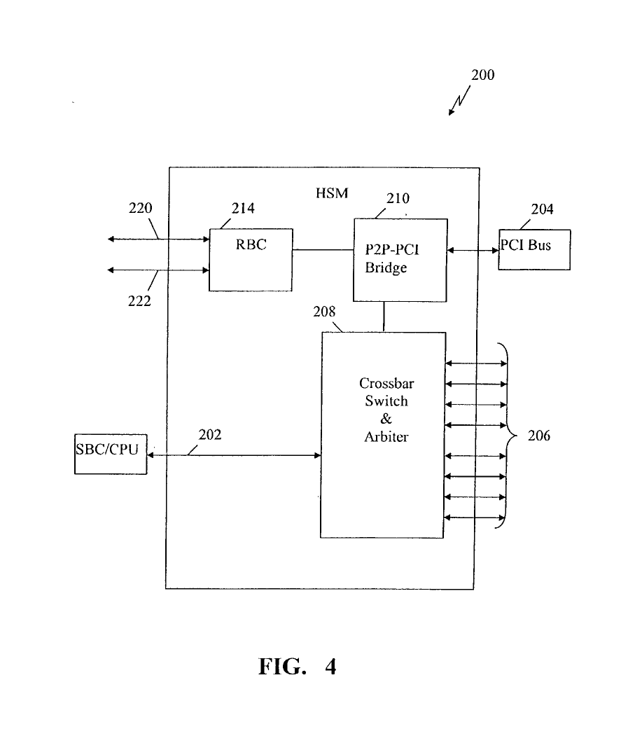

This can be expanded to N connections through the I/O link 218 with arbitration being handled in a crossbar switch 208 (see FIG. 4) in each hybrid switching module, managed and controlled, in one embodiment, by middleware. A middleware layer can additionally be configured to provide distributed services, such as check pointing, fault management, and N+M network configuration management software.

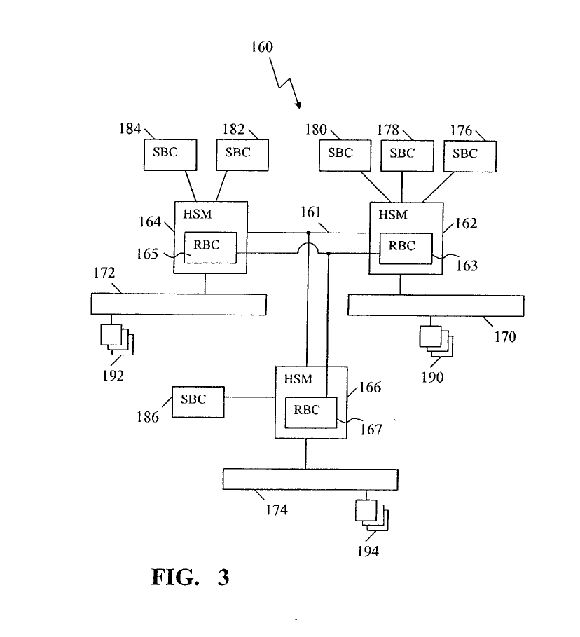

FIG. 3 depicts a simplified block diagram of a network 160 according to one embodiment of the present invention. The network includes three HSMs 162, 164, 166, where each HSM is coupled to one PCI or CPCI bus 170, 172, 174 and one or more SBCs. For example, a first HSM 162 can be coupled with a first, second and third SBC 176, 178, 180, respectively; the second HSM 164 can be coupled with a fourth and fifth SBC 182, 184, respectively; and the third HSM 166 can be coupled with a sixth SBC 186. As such, the network allows the coupling of N SBCs (e.g., six SBCs 176, 178, 180, 182, 184 and 186) with M CPI or CPCI buses (e.g., three buses 170, 172 and 174). The HSMs 162, 164, 166 are coupled through I/O links 161. The HSMs each include an RBC 163, 165, 167 to allow one of the plurality of SBCs access to and control over the bus and peripherals 190, 190, 194. In one embodiment, the RBCs 163, 165, 167 additionally couple together to coordinate bus control.

Again, according to PCI limitations, only one of the SBCs can control the bus at a time. As such, the SBCs can be scheduled to rotate the control of the buses, and/or take control if one of the other SBCs fails. Unscheduled interrupts can occur when there is a failure, power outage or other fault with an SBC. Alternatively, the SBCs can be scheduled to be interrupted or to halt operation allowing other SBCs to access peripherals without having to go through other SBCs. For example, the first, second and third SBCs 176, 178 and 180, through the first RBC 163 of the first HSM 162, can be schedule such that each takes turns accessing the first PCI or CPCI bus 170. Additionally, the network 160 can be configured such that fourth SBC 182 takes control of the second bus 172 if the fifth SBC 184 fails, while the first SBC 176 takes control of the second PCI or CPCI 172 if the fourth SBC 182 fails.

In some embodiment, each HSM 162, 164, 166 includes an RBC 163, 165, 167, respectively. The RBCs monitor the PCI and/or CPCI bus and allows multiple SBCs to gain access and control to the PCI and/or CPCI buses. The RBCs provide for the ability to switch an assignment and dynamic re-assignment of the PCI bus. Previous systems are restricted by the PCI architecture which does not allow multiple components to control the bus. The present invention incorporates the RBC to allow any number of SBCs to gain access to and control over the buses. The RBC provides control to arbitrate, to do bus assignment, ownership initialization, ownership reassignment, and other similar functions, as well as failure detection and take over ownership.

Referring next to FIG. 4, illustrated is a simplified block diagram of a hybrid switching module (HSM) 200 according to one embodiment of the present invention. The HSM includes a crossbar switch and arbiter 208, a bridge 210 and a RBC 214. The HSM additionally includes a PCI CPU bus connection 202 providing coupling with the CPU/SBC 102, 104 (see FIG. 2) and allowing communication of data and/or information between the SBC and HSM 200. The HSM further includes a main bus connection 204 that couples the HSM with a bus, such as the PCI or CPCI bus 106, 118 (see FIG. 2). The HSM also includes input/output (I/O) links 206 that provide coupling between the HSM 200 and other HSMs within a system or network 100 (see FIG. 2).

The crossbar switch and arbiter 208 provides arbitration and switching between the I/O links 206, the PCI bus 204 and the SBC or host. In one embodiment, the crossbar switch and arbiter is implemented through, at least in part, an INTEL switch and arbiter (e.g., INTEL Part No. 82808) or similar chips manufactured by StarGen, Mellanox and other chip manufacturers. The bridge 210 provides the bridging between the SBC and the bus translating signals between the SBC and PCI or CPCI bus.

In one embodiment, the bridge 210 is implemented through an INTEL bridge (e.g., INTEL Part. No. 21554).

The RBC 214, as described above, allows alternate SBCs to access the bus in to the event of a host SBC interrupt and/or failure. In some embodiments, the RBC includes a peer RBC channel coupling 220. The peer RBC coupling allows a plurality of RBCs associated with the same bus or a plurality of RBCs of a network to communicate and coordinate operations. Typically, the peer RBC coupling 270 allows the RBCs to ensure that only a single component controls the bus at a given time. In some embodiments, the RBC additionally includes a PCI control input/output 222. The PCI control signal allows the RBC to maintain control over the bus. In one embodiment, the PCI control signal initiates transitions between controlling the bus in an active state, and releasing control in a standby state. These control signals can include well known PCI control signals, as well as additional controls. The RBC control signal can include those controls over PCI buses well known in the art. In one embodiment, the PCI control signal 222 allows the RBC to receive instructions to transition between hosts. The RBC couples with the bridge 210 and controls the bridge operation. The RBC is typically implemented through a combination of hardware and software. However, in some embodiments, the RBC is implemented only through hardware, or only through software. The RBC can be configured as an individual integrated chip, or incorporated in a chip with additional functions (e.g., within an HSM chip or chip set). In one embodiment, the HSM 200 is implemented through a multi-chip module. Alternatively, the HSM can be implemented as a single integrated device, such as a single chip integrated circuit including the crossbar switch and arbiter 208, the bridge 210 and RBC 214.

Still referring to FIG. 4, the main bus connection 204 is coupled to the respective backplane bus, such as PCI backplane buses 170, 172 or 174 (see FIG. 3). Data received through the PCI backplane bus is received in the PCI main bus connection 204 and directed to the bridge 210. The bridge 210 directs the data from the PCI main bus connection 204 to the crossbar switch and arbiter 208, and performs other bridge functions, such as are well understood by the person of ordinary skill in the art. The PCI CPU bus connection 202 is coupled directly to the respective SBC 162, 164, 166 (see FIG. 3). The switch and arbiter 208 directs communication between the SBC and the bridge, between the SBC and the I/O links, and/or between the I/O links and the bridge.

In one embodiment, arbitration/switching of data, information and/or signals from the SBC and the PCI or CPCI, or between the HSMs 104, 114 is handled in the crossbar switch 208. In one embodiment, the arbitration/switching is controlled by middleware (e.g., cluster software, such as is widely available) executed by the HSM or alternatively executed by the SBC that directs the HSM via the crossbar switch. When the first SBC 102 communicates and/or accesses the first PCI or CPCI 106, the bridge 210 translates signals from the SBC into signals on the PCI or CPCI bus. When the first SBC 102 communicates and/or accesses a second PCI or CPCI bus 118 through a second RBC 132 (see FIG. 2) during an interrupt of the second SBC, the first crossbar switch 208 directs signals from the first SBC 102 over the I/O links 112 where the second crossbar switch of the second HSM 114 and RBC 132 (see FIG. 2) directs a second bridge to translate the signals from the first SBC into signals on the second or CPCI bus 118.

Functioning of the HSMs 200, and in particular the operation of the crossbar switch and arbiter 208, in order to direct data from the respective SBCs to the appropriate PCI backplane bus or other SBC, may be programmatically controlled, for example, by the single board computers. Alternatively or additionally, the functioning of the HSM may operate as a result, for example, of heartbeats that detect failure of various components within the industrial computer system allowing the HSM to switch out SBCs in the event a failure is detected of a SBC.

As a result, most and preferably all of the PCI peripheral slots 108, 120, and the user rear PCI input/output devices 110, 122 can be accessed by an alternate SBC of the network 100. This allows one SBC (e.g., first SBC 102) to serve as a backup to one or more other SBCs (e.g., second SBC 116), while not requiring full redundancy of the PCI peripheral cards in the PCI peripheral slots 108, 120 or the user PCI input/output devices 110, 122. This multi-computing backup can be extended to multiple SBCs.

Any number of SBCs (N number of SBCs) can gain access to any number of PCI or CPCI buses (M number of PCI or CPCIs).

In one embodiment, the data flow through the crossbar switch and arbiter 208 is controlled by software depending on the mode of operation. In the case of SBC/CPU failure, for example, a failover operation takes place, an available SBC/CPU in the network takes over and is coupled to the PCI or CPCI backplane bus through the HSM 200 controlled by the RBC 214. Thus, the present invention provides a means of maintaining operation and access to peripheral devices on buses during SBC/CPU failure and/or interrupts.

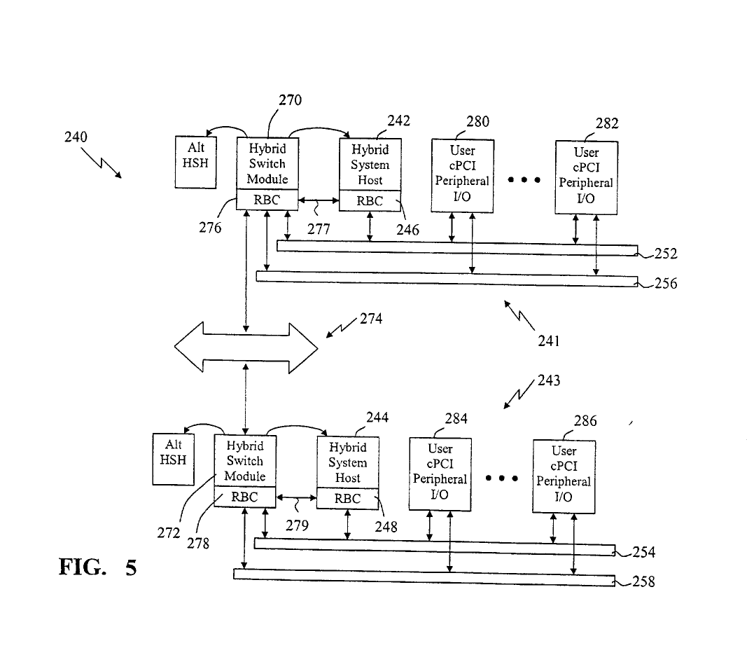

Still referring to FIG. 4, the present invention utilizes the RBCs 214 within HSMs 200 to allow multiple controllers of the PCI and/or CPCI bus 204. This provides significant advantages over previous systems that only allow a single component, such as a single CPU or SBC, to control the communication of data, information and/or control signals over the PCI and/or CPCI. The present invention allows any number of SBCs to access the bus without requiring the SBCs to go through an additional SBC. In one embodiment of the present invention, the RBC 214 couples through a peer RBC connection 220 with at least one additional RBC of another component of the network or system 160 (see FIG. 5). For example, the RBCs associated with a single bus, such as single PCI bus, communicate over the peer RBC connection 220 to coordinate the control of that bus.

FIG. 5 depicts a simplified block diagram of a computer network 240 according to one embodiment of the present invention. The network includes a plurality of computer systems 241, 243. Typically, each computer system includes a CPU, hybrid system hosts (HSH) and/or SBC 242, 244. In one embodiment, each computer system 241 and 243 includes a plurality of communication lines or buses. For example, each system 241, 243 can include a PCI or CPCI bus 252, 254, respectively, and an H.110 bus, 256, 258, respectively. This allows each system to provide additional communication and incorporate additional peripheral I/O devices 280, 282, 284, 286.

In one embodiment, the SBCs 242, 244 can couple directly with one or more of buses. For example, the first and second SBCs 242, 244 can couple directly with the respective first and second PCI buses 252, 254 to communicate and interact with the peripheral devices. Each system 241, 243 can additionally include an HSM 270, 272, respectively. The SBCs couple with the HSMs allowing the SBCs to couple indirectly with one or more of the additional buses within the systems (e.g., H.110 buses 256, 258) as well as allowing the SBCs to be coupled with the other computer systems within the network 240 through a point-to-point switching fabric 274 established, in part, through the HSMs and I/O links 112 (see FIG. 2).

The HSMs 270, 272 provide one or more paths for one or more remote SBCs 242, 244 to access and act as the system host to one or more local bus segments 252, 254, 256, 258. The HSM can include an RBC 276, 278 which can be active allowing an SBC to access the bus through the HSM, or act as the standby to an active RBC of an SBC or another HSM on the local bus segment. Multiple HSMs interconnect together through the I/O links to form the distributed switching network or fabric 274. This distributed switching fabric eliminates, the need of dedicated fabric switch boards and/or boxes. The established switching fabric extends the bus(es) (e.g., PCI, cPCI or H.110 buses) across chassis boundary.

The HSMs 270, 272 can additionally couple with the buses with which the SBCs directly couple (e.g., first and second PCI buses 252, 254, respectively). This allows SBCs within the network to access and/or control the buses (and thus peripheral devices) within other computers systems of the network 240. For example, a first SBC 242 can access the second PCI bus 254 of the second computer system 243 through the first HSM 270, the switching fabric 274 and the second HSM 272, without the need to go through the second SBC 244, while still directly accessing the first PCI bus 252 without communicating through the first HSM 270.

In one embodiment, the SBCs 242, 244 and the HSMs 270, 272 each include RBCs 246, 248, 276, 278, respectively. The RBCs, as described above, allow multiple components to control the buses 252, 254, 256, 258. As such, the SBCs can control one or more of the buses directly through SBC RBCs 246, 248 or indirectly through the HSM RBCs 276, 278.

The SBCs 242, 244 are capable of directly being the system host on the PCI or bus segments 252, 254 through the RBCs 246, 248. The RBCs can be activated when the SBCs are in a native attach mode. Alternatively, the RBC function is not used and in standby if an alternate SBC is controlling the bus. Similarly, the RBCs of the SBCs are not used when the SBCs remotely access other buses segment (e.g., H.110 buses) 256, 258 through the HSMs 270, 272.

For example, in operation the first SBC 242 can control the first bus 252 through the first RBC 246. The first SBC 242 can also access and control the second bus 256 through the first HSM 270 and second RBC 276. If the first SBC should fail, the second SBC 244 can access and gain control over the first bus 252 through the first HSM 270 and second RBC 276. The failure can be a scheduled or unscheduled failure. The first and second RBCs 246, 276 couple through peer RBC coupling 277 to coordinate control over the first bus 252. As such, when the first SBC experiences a failure, the first RBC 246 and the second RBC 276 communicate to coordinate the release of control by the first RBC over the first bus 252, allowing the second RBC 276 to take over control and provide the second SBC 244 with access to the first bus 252 and peripherals 280, 282. Similarly, the second SBC 244 can also gain access and control to the second bus 256 of the first system 241 through the first HSM 276.

The network 240 is typically implemented through both hardware components and software. In one embodiment, the SBC (e.g., first or second SBC 242 or 244) is implemented through hardware, such as one or more CPU chips, microprocessor chips (e.g., Pentium chips) and/or other chip or chips. The HSM (e.g., first or second HSM 270 or 272) can also be implemented through one or more chips. The RBC (e.g., RBC 246, 248, 276 or 278) can also be implemented through hardware. In one embodiment, the RBC is incorporated within the SBC or HSM chip(s). In one embodiment, the RBC is implemented through an individual chip or chip set that couples and cooperates with the HSM or SBC and the buses.

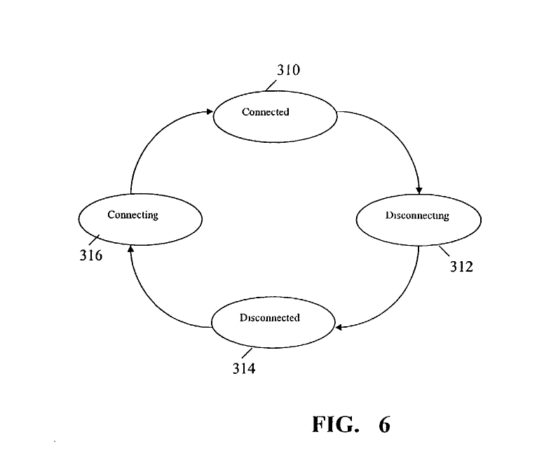

The RBCs communicate over the peer RBC coupling 277, 279 to coordinate the transition of control from one RBC to another. When the first RBC 246 causes a release of control over the first bus 252 to allow the second RBC 276 to provide and alternate SBC to take control, the first RBC communicates with the second RBC. FIG. 6 depicts a state diagram of the operation of the RBCs. For example, referring to FIGS. 5 and 6, in a first active or connected state 310, the first RBC 246 is connected with the first bus 252 and allows the first SBC 242 to control the bus. Because PCI buses are limited to only a single controller, the second RBC 276 of the first HSM 270 is in the third state 314 and disconnected from the bus. When the first SBC 242 experiences a failure or interrupt, the first RBC 246 causes a release of control over the bus, the first RBC transitions states from the first state 310 to the second state 312 of disconnecting control over first the bus 252. The first RBC 246 can signal the second RBC 276 indicating that it is releasing control. The states of hardware and/or other I/O devices of the bus can be halted and/or stored. The fist RBC continues to transition states to the third state 314. In the third state 314, the first RBC disconnects from control over the bus and signals the second RBC 276 indicating the disconnect and release of control.

The second RBC receives the signal over the peer RBC coupling indicating a release of control over the bus. The second RBC then transitions from the third state 314 of standby or disconnected to a fourth state 316 where the second RBC is connecting with and establishing control over the bus. The second RBC 276 can communicate to the first RBC 246 indicating the taking over of control. The second RBC then transitions to the first state 310, to be active and connected with the first bus 252 and provides the second SBC 244 with control over the bus. The second RBC 276 communicates with the first RBC 246 informing the first RBC that the second RBC is active and has control over the bus. The hardware and/or I/O devices can be re-initiated at their previous states and under control of the second SBC 244. In one embodiment, the second RBC 246 cannot gain access and control over the bus until the first RBC 276 releases control from the third state 314.

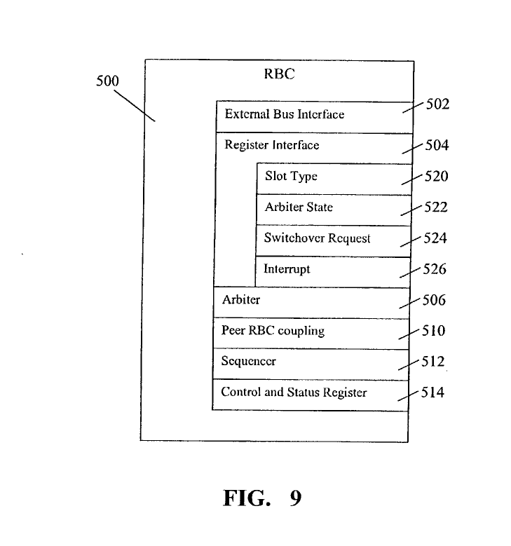

In one embodiment, the RBC includes a sequencer 512 (see FIG. 9). When the RBC is to transition from one state to another, for example, from the first state 310 of active/connected to the third state 314 of standby/disconnected, the sequencer is activated causing the transition through the states to the destination state (e.g., third state 314, disconnected). In one embodiment, the RBC is controlled in part by software. The software instructs the RBC to transition states and activates the sequencer.

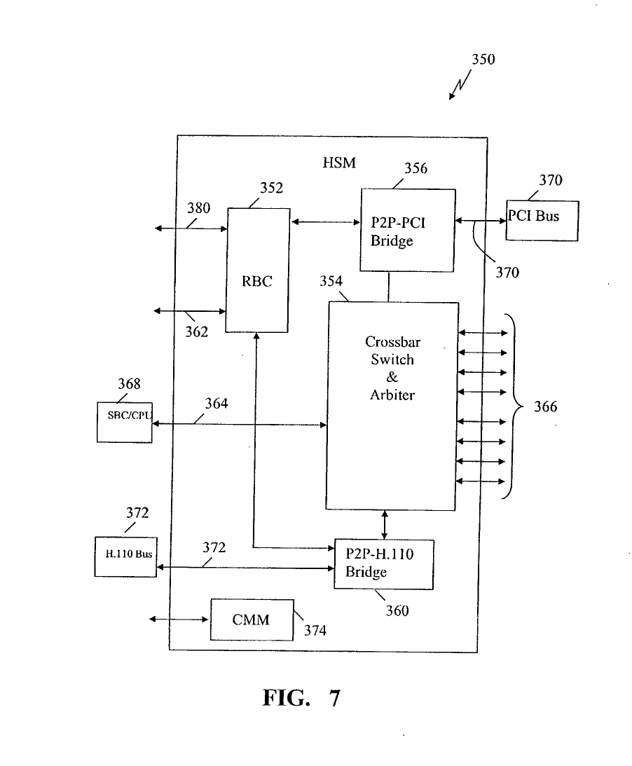

FIG. 7 depicts a simplified block diagram of an HSM 350 that allows coupling, cooperation and control over a plurality of buses within a network 240 (see FIG. 5). The HSM includes an RBC 352, a crossbar switch and arbiter 354, a first bridge 356 (for example a point-to-point PCI bridge) and a second bridge 360 (for example a point-to-point H.110 bridge). The RBC 352 couples with other RBCs within the network through a peer RBC coupling 362. The RBC additionally can include a bus control coupling 380 (e.g., PCI control and/or H.110 control coupling) allowing the RBC to maintain control over the buses. The HSM 350 additionally includes one or more SBC bus connections 364 providing coupling with one or more SBCs 368 allowing communication of data and/or information between the SBC and HSM 350. The SBC bus connection 364 couples with the crossbar switch and arbiter 354 which switches data between the SBC and other communication links of the network, such as the I/O links 366 establishing part of a switching fabric 274 (see FIG. 5), a PCI bus 370, H.110 bus 372, and other such communication links.

The first bridge 356 couples with and bridges communication between the switch and arbiter 354 and a first bus 370 (e.g., a PCI or CPCI bus). The second bridge couples with and bridges communication between the switch and arbiter 354 and a second bus 372 (e.g., an H.110 bus). The RBC 352 additionally couples with the first and second bridges 356, 360 to control the communication through the bridges 356, 360 and over the buses. The RBC activates the bridge or bridges 356, 360 to allow communication between the controlling SBC 368 and the bus or buses 370, 372.

In one embodiment, the bridges include bridge drivers and application program interfaces that are implemented through software. The RBC 352 includes a device driver and application program interface that are implemented through software. The crossbar switch and arbiter can include software for providing bus ownership assignment as well as software for dynamic reassignment of bus ownership (for example, when a node failure occurs). The network can additionally include software for implementing socket interface for IPCs (interprocess communications). In one embodiment, the HSM 350 includes a system management module (SMM) and/or chassis management module (CMM) 374 providing system communications and/or control.

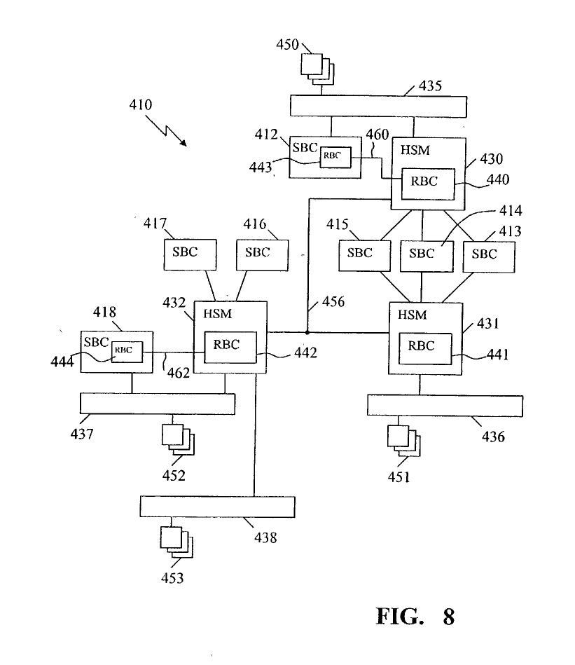

The SMM 374 can be configured to perform CMC and baseboard management controller (BMC) functions. In one embodiment, the CMC and BMC functions are provided as described in the PCI Industrial Computer Manufacturers Group (PICMG) 2.9 Specification. The SMM can be further configured to monitor and control the system environment, such as the cooling system for the enclosure, power subsystem, and other similar functions. The SMM can further activate alarms when a preset threshold is exceeded. The SMM can also include a hot swap controller which controls the connection process of an individual slot by monitoring inputs. Additionally, the SMM can be configured to support redundant operation with automatic switchover under hardware or software control. In one embodiment, to avoid single point of failure, the SMM supports a dedicated intelligent management platform bus (IPMB) to each slot, for example, in a star topology. FIG. 8 depicts a simplified block diagram of a computer network 410 according to one embodiment of the present invention. The network 410 includes a plurality of SBCs or processors 412-418. The SBCs couples with at least one HSM 430-432. Each HSM couples with one or more buses 435-438, for example a PCI or CPCI bus and/or an H.110 bus. Each HSM further includes an RBC 440-442 for controlling access to the one or more buses 435-438. Additionally, two of the SBCs, first SBC 412 and seventh SBC 418 include RBCs 443-444, and directly couple with one or more buses 435 and 437, respectively. In one embodiment, one or more of the RBCs are implemented in part through one or more switches selecting one of the SBCs.

The second through sixth SBCs 413-417 each couple with one of the HSMs 430-432 and gain access and control over one of the buses 435-438 through the HSMs and RBCs 440-442 of the HSMs. One or more peripheral devices 450-453 couple with each of the buses 435-438. The SBCs 412-418 access the peripheral devices 450-453 over the buses. Typically, a plurality of HSMs, and preferably all of the HSMs 430-432 couple with one another through I/O links 456 establishing the switching network 274 (see FIG. 5).

The first SBC 412 can directly access and control the first bus 435 utilizing the first SBC RBC 443. The first HSM 430 additionally couples with the first bus 435 to providing the second, third and fourth SBCs 413-415 with access and control of the first bus 435. The first SBC RBC 443 couples with the first HSM RBC 440 through peer RBC coupling 460. Through the peer RBC coupling 460, the two RBCs 440 and 443 ensure than only one SBC through one RBC controls the first bus 435 at a time. For example, when the RBC 443 of the first SBC 412 is active and in a connected state, the RBC 440 of the first HSM 430 is in a disconnected state and in standby, preventing one of the second, third or fourth SBCs 413-415 from controlling the first bus 435. If a failure or interrupt occurs with the first SBC 412, then the RBC 443 of the first SBC causes a disconnect and communicates to the RBC 440 of the first HSM 430 that it has disconnected. The RBC 440 of the first HSM 430 can then connect to the first bus 435 and allow one of the second, third or fourth SBCs 413-415 to control the bus and access the peripheral devices 450.

Additionally, through the third HSM 432 and I/O links 456, one of the sixth, seventh or eighth SBCs 416-418 can also access the first bus 435 in the event of a failure or interrupt.

The second HSM 441 provides the second, third and fourth SBCs 413-415 with access to the second bus 436 and associated peripheral devices 451. Again, only one of the SBCs gains control over the bus through the RBC 441 of the second HSM 441. The control can be scheduled, or one can be active while the others become active upon a failure or other predetermined event. One of the first, sixth, seventh or eighth SBCs 412, 416-418, respectively, can also access the second bus 436 in the event of a failure, interrupt, schedule or event, through the first or third HSM 430, 432 and the I/O links 456.

Similar to the first SBC 412, the eighth SBC 418 can directly access and control the third bus 437 through the RBC 444 of the eighth SBC 418. The eighth SBC 418 can additionally access and control the fourth bus 438 through the third HSM 442. Alternatively, one of the sixth and seventh SBCs 416-417 can access and control the third and/or fourth bus 437-438 through the third HSM 432. Additionally, one of the first through fifth SBCs 412-415 can access and control the third and/or fourth buses 437, 438 through one of the first or second HSMs 430, 431 and the I/O links 456.

The RBC 444 of the eighth SBC 418 is coupled with the RBC 442 of the third HSM 432 through peer RBC coupling 462. Again, the peer RBC coupling allows the RBCs 442 and 444 to communicate and coordinate the control of the third and fourth buses 437, 438. If the RBC 442 of the third HSM 432 is active, then the RBC 444 of the eighth SBC 418 is in standby. When a fault, interrupt or event occurs, the control can transition between the RBCs allowing the other SBCs to access and control the third and/or fourth bus 437, 438.

The present invention can be configured to include one or more clusters of SBC″s, where one, a plurality or all of the SBCs may be active and running user applications under the control of a clustering middleware. In one embodiment, the clustering middleware is implemented through well know techniques and/or commercially available middleware, such as Win2K AS Server Cluster, Red Hat Linux AS Cluster, and other such middleware.

In one embodiment, an alternate backup node is assigned to each active host node of a bus segment or domain. When an active host fails, the alternate host assumes ownership through the RBCs of the I/O devices on the failing bus segment and resumes user applications. In one embodiment, this function utilizes checking-pointing of application critical data to the designated alternate host node using the distributed check-pointing services of middleware. In addition, the present invention can specify the unit of recovery for retry of the alternate host to resume interrupted operation. In one embodiment, to support timely switchover to an alternate node in the event of a host failure, an application program interface (API) can be utilized to allow the application to check point operational contents used to complete a successful application switchover to the alternate node.

The RBCs control SBC access to the bus (e.g., PCI, cPCI, H.110 and other buses). An active SBC has access to the bus and a standby SBC does not have access to and is typically isolated from the bus while the active SBC is active. The RBC(s) arbitrate with one or more peer RBCs to determine which of the one or more RBCs is active and which is/are standby. The RBCs cooperate to prevent a plurality of SBCs from simultaneously being active on a single bus. Further, the RBCs support a switchover from an active to a standby state, for example, in a cooperative switchover. In one embodiment, this switchover is software initiated. Similarly, the RBCs support switchover from a standby to an active state, for example, in a forced takeover. This switchover can also be software initiated. The RBCs additionally provide automatic switching from a standby to an active state in response to a peer RBC changing from an active to a standby state. In one embodiment, the RBCs generate interrupt signaling to a host of a state change. The RBCs are typically configured to provide an orderly transition of bus signals when switching from active to standby and from standby to active. This includes but is not limited to the clocks and bus grants.

The RBC can be implemented through hardware and/or software. Further, the RBC can be implemented on one or more chips. FIG. 9 depicts a simplified block diagram of an RBC 500 and some examples of the functional blocks that can be included the RBC. In one embodiment, the RBC 500 includes an external bus interface 502 that provides software access to a register interface 504. The register interface 504 in turn provides software control and status of RBC operation. The RBC includes an arbiter 506 which determines, based on peer RBC input 510 from one or more other RBCs, if the RBC state is active or standby. The arbiter is configured to prevent more than one of a plurality of host slot boards from being active. Further, the RBC includes a sequencer 512 which is configured to provide an orderly transition of bus signals during a change from an active to a standby state or from a standby to an active state.

The RBC register interface 502 can include several function blocks, including, but not limited to, a slot type 520, arbiter state function block 522, switchover request function block 524, and an interrupt 526. The slot type 520 defines the type of slot, which is typically defined as primary or secondary. The arbiter state function block 522 defines the state of the RBC. The switchover request function block 524 is configured to receive and/or generate a request to cause the RBC 500 to initiate a state change. In one embodiment, this switchover request function block is software initiated. The interrupt 526 signals a switchover event and interrupt reset.

The RBC 500 can additionally include a control and status register (CSR) 514. In one embodiment, the RBC maintains control and status information through CSR 514. The register can be of substantially any size. For example, the register can be six (6) bits where each bit defines control or status information. One bit, e.g., a least significant bit, can identify a slot position, where a zero (0) indicates a host slot 0, and a 1 indicates a host slot 1. A second bit can identify the arbiter state, where a zero can indicate a standby state and a 1 can indicate an active state. A third bit can be an active request that can be activated through software to request a change to an active state. A zero can indicate a “no request” and a 1 can indicate an “active request.” This bit can be automatically reset when the RBC transitions to an active state. A fourth bit can be a standby request that can be activated through software to request a change to standby state. A zero can indicate a “no request” and a 1 can indicate a “standby request.” This bit can also be automatically reset when the RBC transitions to the standby state. A fifth bit can indicate an active interrupt activated by the arbiter to indicate a change from standby to active. A zero can indicate “no interrupt” and a 1 can indicate an “interrupt.” This bit can be reset by software through a reset interrupt bit. The six bit can be the reset interrupt bit utilizes to clear an interrupt. This bit can be activated by software. A zero can indicate a no reset or no clear and a 1 can indicate a reset or clear. Other bits can be included in the register for other control and/or status information. Additionally, the register can be larger with some bits reserved for other functions or future use. It will be apparent to one skilled in the art that the register can use a plurality of bits to designate these and other control and status information (for example, a plurality of bits can be used to designate any number of slots).

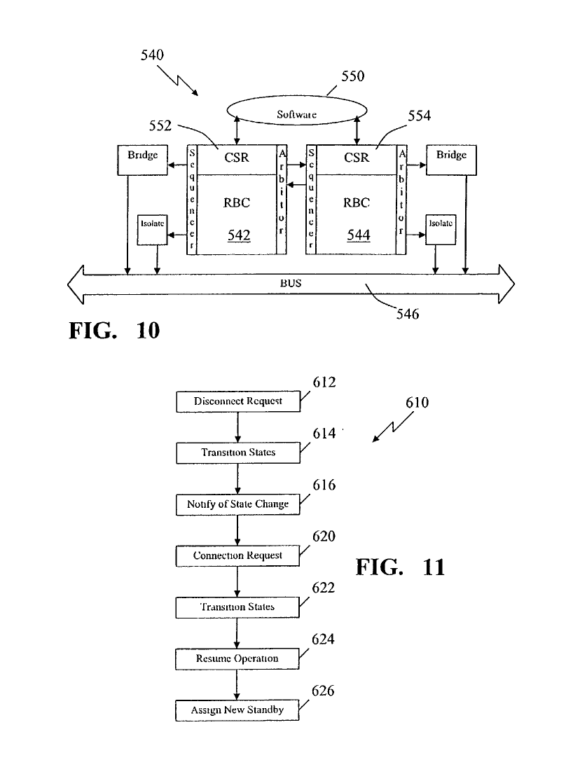

FIG. 10 depicts a simplified block diagram of two RBCs 542, 544 in an active/standby configuration and their relation to other components in a system 540. Typically, the RBCs initialize their states during a system power-on sequence, an interrupt or some other even (e.g., an instruction from some other network component). In one embodiment, the RBCs associated with a bus 546 initialize their operating state based on their slot location. The RBC in a designated primary slot can initialize to an active state and one or more RBCs in designated alternate one or more slots initialize to standby. In one embodiment, if the primary slot is empty, the RBC in an alternate slot or a first alternate slot initializes to the active state.

In one embodiment, following the initial determination of the RBCs″ states (e.g., during a system power-on sequence), software 550 external to RBCs can be implemented to be responsible for determining and maintaining which RBC is active. If it is necessary to switch a RBC state, the software 550 uses the RBC CSR 552, 554 to perform the switchover.

FIG. 11 depicts a flow diagram showing a process 610 for transitioning control over a bus from one host to another host. In step 612 a disconnect is submitted to the current active host or the current active host signals an initiation of a disconnect. For example, middleware can initiate a software disconnection request (e.g. PrepareForSwitchover) to the active host. This step can be initiated as a scheduled transition or due to a failure. The active host halts operation to ensure that bus devices appear to the new owner/host in a known state and that transactions in progress are not lost. In step 614 the current RBC and active host transition from a connected state 310 to a disconnecting state 312 and then to the disconnected state 314 (see FIG. 6). When the disconnection process is completed, the process 610 transitions to step 616 where the current host notifies the standby host and/or middleware. In one embodiment, when the current host notifies the standby host and/or middleware, check-pointed data and/or status information regarding components on the bus is also forwarded. In step 620 a connect request is submitted to the standby host or the standby host signals an initiation of a connect. For example, middleware can initiate a software connection request (e.g. PerformSwitchover) to the new host, i.e. the standby host. In step 622, the new RBC and host transition from the disconnected state 314 to the connecting state 316 to the connected state 310 (see FIG. 6). In step 624 the new host starts the drivers for bus devices in the domain and resumes normal operation. In step 626, middleware assigns a new standby node to the new active host.

Through the utilization of the RBC, an SBC can be designated as an alternate of another SBC controller for a bus segment in the same chassis. In a multiple chassis configuration, one or more SBCs in one or more chassis may be designated as the alternate controllers for one or more bus segments in another chassis accessing I/O devices through the switching fabric. Additionally, one host or SBC can own or control more than one bus segment. Further, a single standby host node can be assigned to more than one active host. When a shared standby host node becomes a new active host taking over for another host, a new standby node can be assigned to the newly activated host.

The present invention can be implemented utilizing a hybrid switching architecture for establishing, in part, the switching fabric as described above. The hybrid switching architecture is more fully described in co-pending U.S. patent application Ser. No. 09/___,___, entitled HYBRID SWITCHING ARTCHITECTURE, filed XXXX--, 2002, incorporated in its entirety herein by reference.

The HSMs with RBCs are used to interconnect existing islands of PCI, cPCI and/or H.110 bus segment(s) and to form a switching fabric for clustering multiple controller hosts. The system platform allows bus segments to integrate and interoperate with fabric attached boards, such as server blades, network blades, storage blades, and other such boards in a switching fabric centric system. This architecture provides a unique platform for PCI-bus-centric users to smoothly migrate into a fabric centric system configuration. It allows the two distinctly different architectures to co-exist, integrate, and interoperate together. It achieves high availability by leveraging N+M redundant hardware components through out the entire system.

While the invention herein disclosed has been described by means of specific embodiments and applications thereof, numerous modifications and variations could be made thereto by those skilled in the art without departing from the scope of the invention set forth in the claims.

1. A network, comprising:
a first processor including a first processor data channel;
a first hybrid switching module (HSM) including a first HSM processor data channel coupled with the first processor data channel, a first HSM first bridge, a first HSM redundant bus controller (RBC) coupled with the first HSM first bridge, wherein the first HSM RBC includes a first HSM peer RBC channel, and a first HSM first main bus channel coupled with the first HSM first bridge;
a first main bus coupled with the first HSM first main bus channel, such that the first HSM first bridge bridges communication between the first processor and the first HSM first main bus when authorized by the first HSM RBC;
a second RBC having a second RBC peer RBC channel coupled with the first HSM RBC peer RBC channel; and
a second processor including a second processor data channel coupled with the first main bus such that data is communicated between the second processor and the first main bus when the first HSM RBC is in standby.

2. The network as claimed in claim 1, further comprising:
a second HSM including the second RBC, a second HSM processor data channel coupled with the second processor data channel, and a second HSM bridge coupled with the second RBC, wherein the second HSM bridge includes a second HSM main bus channel coupled with the first main bus such that the second HSM bridge bridges communication between the second processor and the first main bus when authorized by the second RBC.

3. The network as claimed in claim 2, wherein the first HSM RBC communicates first HSM RBC state information to the second RBC.

4. The network as claimed in claim 3, wherein the second RBC communicate second RBC state information to the first HSM RBC.

5. The network as claimed in claim 1, wherein the first HSM including a first HSM input/output (I/O) link channel;
a third processor having a third processor data channel; and
a third HSM including a third HSM processor data channel coupled with the third processor data channel, a third HSM I/O link channel coupled with the first HSM I/O link channel, and a third HSM switch that selectively couples with the third HSM processor data channel and selectively couples with the third HSM I/O link channel, wherein the third HSM processor data channel is thereby selectively coupled with the third HSM I/O link channel.

6. The network as claimed in claim 5, wherein the first HSM including a first HSM switch that selectively couples with the first HSM first bridge and couples with the first HSM I/O link channel, wherein the first HSM I/O link channel is thereby selectively coupled with the first HSM first bridge.

7. The network as claimed in claim 5, wherein the first HSM including a first HSM switch such that the first HSM switch selectively couples with the first HSM processor data channel, the first HSM first bridge and the first HSM I/O link channel, wherein the first HSM processor data channel is thereby selectively coupled to the first HSM first bridge and selectively coupled to the first HSM I/O link channel.

8. The network as claimed in claim 1, further comprising:
a third HSM including a third HSM RBC, a third HSM main bus channel, a third HSM bridge which couples with the third RBC and with the third HSM main bus channel, a third HSM I/O link channel, and a third HSM switch selectively coupled with the third HSM bridge and selectively coupled with the third HSM I/O link channel;
a third main bus coupled with the third HSM main bus channel; and
the first HSM including a first HSM I/O link channel coupled with the third HSM I/O link channel, and a first HSM switch selectively coupled with the first processor data channel and selectively coupled with the first HSM I/O link channel, wherein the first HSM processor data channel is thereby selectively coupled with the third HSM main bus channel.

9. The network as claimed in claim 1, wherein the first HSM including a first HSM second bus data channel and a first HSM second bridge coupled with the first HSM second bus data channel.

10. The network as claimed in claim 9, wherein the first HSM including a first HSM switch coupled with the first HSM processor data channel, selectively coupled with the first HSM first bridge and selectively coupled with the first HSM second bridge coupled, wherein the first HSM processor data channel is thereby selectively coupled with the first HSM first bridge and selectively coupled with the first HSM second bridge.

11. A system, comprising:
a first processor;
a first hybrid switching module (HSM) coupled with the first processor and a first main bus, wherein the first processor accesses the first main bus through the first HSM;
the first HSM includes a first HSM redundant bus controller (RBC);
a second processor coupled with the first main bus; and
a second RBC coupled with the first HSM RBC, wherein the second RBC grants the second processors control over the first main bus when the first HSM RBC is inactive.

12. The network as claimed in claim 11, further comprising:
a second HSM that includes the second RBC, wherein the second processor couples with the second HSM and accesses the first main bus through the second HSM.

13. The network as claimed in claim 11, further comprising:
a third HSM including a third HSM input/output link (I/O link);
a third processor coupled with the third HSM; and
the first HSM including a first HSM I/O link coupled with the third HSM I/O link,
wherein the third processor accesses the first main bus through the third HSM and the first HSM.

14. The network as claimed in claim 13, further comprising:
a second main bus coupled with the third HSM, such that the third processor accesses the second main bus through the third HSM.

15. The network as claimed in claim 11, further comprising:
a fourth processor coupled with the first main bus;
the fourth processor including a fourth processor RBC coupled with the first HSM RBC and the second RBC, wherein the fourth processor RBC controls access of the fourth processor to the first main bus when the first HSM RBC and second RBC are inactive.

16. An apparatus for providing information flow over a data bus, comprising:
a redundant bus controller (RBC);
a first bridge having a first main bus channel, wherein the first bridge couples with the RBC; and
a switch selectively coupled with the first bridge, wherein the first bridge bridges data between the first main bus channel and the switch when directed by the RCB.

17. The apparatus as claimed in claim 16, wherein the switch includes a host channel, such that the switch selectively couples the host channel with the first bridge.

18. The apparatus as claimed in claim 16, wherein the switch includes a host channel and an input/output (I/O) link channel, such that the switch selectively couples the host channel with the I/O link channel.

19. The apparatus as claimed in claim 18, wherein the switch is configured to couple with a remote switch through the I/O link channel.

20. The apparatus as claimed in claim 16, wherein the RBC couples with a remote RBC such that the first bridge bridges data between the first main bus channel and the switch when the remote RBC is in standby.

21. The apparatus as claimed in claim 16, wherein the RBC includes a peer RBC channel, wherein the peer RBC channel couples with a remote RBC such that the RBC and the remote RBC communicate over the peer RBC channel.

22. The apparatus as claimed in claim 16, further comprising:
a second bridge having a second bus channel, wherein the switch selectively couples with the second bridge, such that the second bridge bridges communication between the second bus channel and the switch.

23. An apparatus for controlling access to a bus, comprising:
a peer coupling to communicate state information;
a control and status register; and
a sequencer to transition the state of the apparatus.

24. The apparatus as claimed in claim 23, further comprising:
a register interface coupled with an arbiter.

25. The apparatus as claimed in claim 24, wherein the register interface includes an arbiter state.
